(19) United States
(12) Patent Application Publication
(10) Pub. No.: US 2014/0151077 A1
(43) Pub. Date: Jun. 5, 2014

(54) AGRICULTURAL IMPLEMENT MOUNT SYSTEM

(71) Applicant: Trevor Rollenhagen, Montezuma, IA (US)

(72) Inventor: Trevor Rollenhagen, Montezuma, IA (US)

(21) Appl. No.: 13/693,107

(22) Filed: Dec. 4, 2012

(51) Int. Cl. A01B 59/06

(52) U.S. Cl. CPC A01B 59/06
USPC 172/675

(57) ABSTRACT

An agricultural implement mount system using structural components of an agricultural implement to reduce the redundancy of parts in the agricultural mount. The reduction in part reduces cost, weight and maintenance attributes, while allowing additional visibility of the operator past the agricultural implement mount and agricultural implement secured thereto.

### TECHNICAL FIELD

The present invention relates in general to an agricultural implement mount system and, more particularly, to an agricultural implement mount system with reduced weight and improved visibility characteristics.

### BACKGROUND

High clearance agricultural vehicles are well known in the art. Such vehicle may be used in association with spray booms to apply a material to a crop after the crop has started to grow. One drawback associated with prior art spray booms is the redundancy associated with the structural components of the spray boom and the structural components on the spray boom mount secured to the high clearance agricultural vehicle. Such redundancy not only adds costs and weight to the system, but increases maintenance costs and reduces the visibility of the operator to see past the area where the spray boom connects to the spray boom mount. The difficulties encountered in the prior art discussed hereinabove are substantially eliminated by the present invention.

### SUMMARY OF THE DISCLOSED SUBJECT MATTER

In the preferred embodiment of this invention, an agricultural implement mount system is provided with a frame pivotally mounted to the high clearance agricultural vehicle. Pivotally coupled to the frame is a four-bar parallel linkage having two ends secured to a lift bar and two ends free. An agricultural implement is provided with a support bar coupled to a first lateral boom and a second lateral boom. Posts are provided on the support bar which are coupled to the free ends of the four-bar parallel linkage and to the lift bar.

### BRIEF DESCRIPTION OF THE DRAWINGS

The present invention will now be described, by way of example, with reference to the accompanying drawings in which:

FIG. 1 illustrates a side elevation of the agricultural implement mount system of the present invention pivotally secured to a high clearance agricultural vehicle;

FIG. 2 illustrates a top perspective exploded view of the agricultural implement mount system of FIG. 1;

FIG. 3 illustrates a front elevation of the agricultural implement mount system of the present invention secured to a high clearance agricultural vehicle.

### DETAILED DESCRIPTION OF THE DRAWINGS

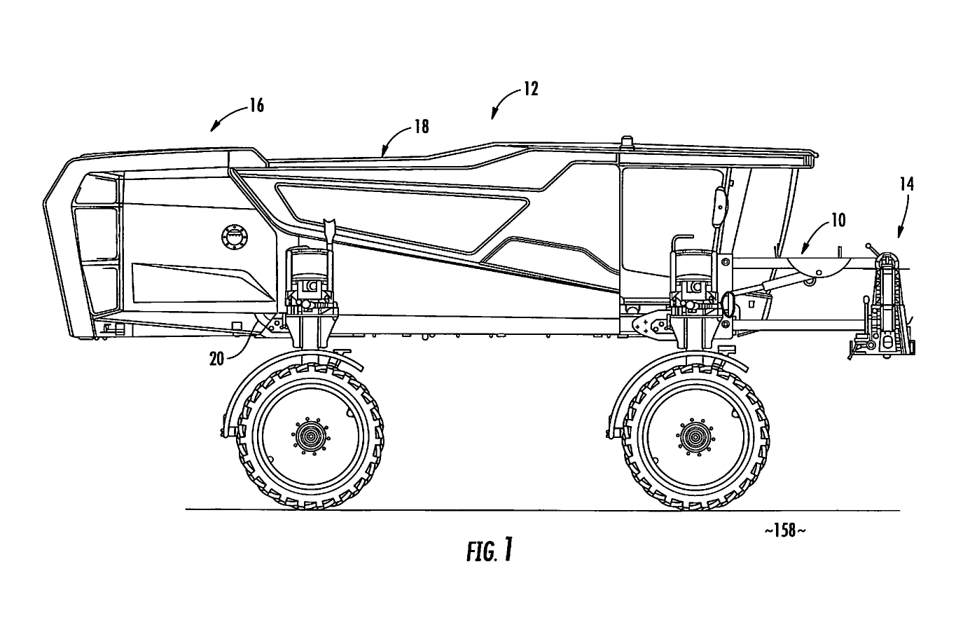

An agricultural implement mount is shown generally as (10) in FIG. 1. The agricultural implement mount (10) couples a high clearance agricultural vehicle (12) to an agricultural implement (14). While the vehicle (12) may be of any type known in the art, in the preferred embodiment, the vehicle (12) is an STS16 Sprayer manufactured by Hagie Manufacturing Company of Clarion, Iowa. U.S. Pat. No. 6,962,210 is incorporated herein by this reference. The agricultural implement (14) is preferably a spray boom for applying material to row crops (22).

The vehicle (12) is provided with a hydraulic motor (16) and a tank (18). In the preferred embodiment, the tank (18) has a capacity in excess of five hundred liters. Provided from the tank (18) to the agricultural implement (14) are a plurality of fluid lines (20) such as those known in the art to supply fertilizer, herbicide and the like from the tank (18) into the crops (22) through the agricultural implement (14).

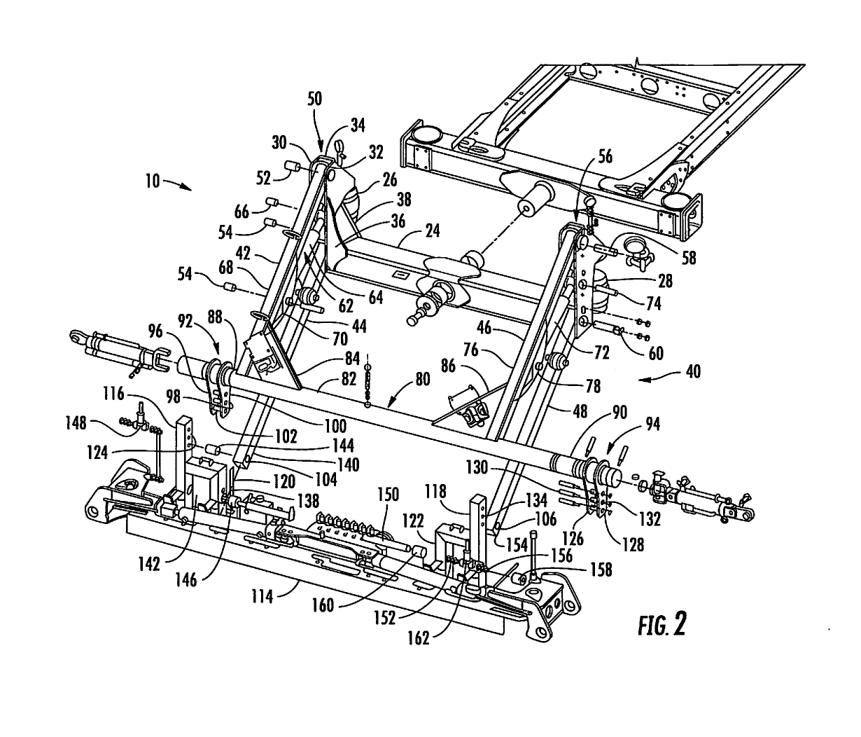

As shown in FIG. 2, the agricultural implement mount (10) is provided with a crossbar (24) secured to a first riser (26) and second riser (28) which form a generally U-shaped frame. Although the crossbar (24) and risers (26) and (28) may be constructed of any suitable material, in the preferred embodiment they are constructed of steel. The first riser (26) and second riser (28) are preferably mirror images of one another so this description will be limited to that of the first riser (26).

The first riser (26) is provided with a first sidewall (30) and a second sidewall (32) secured to a back wall (34), forming a channel (50) having a generally U-shaped cross section. The first riser (26) is secured to the end of the crossbar (24) by weldments and may be provided with additional support brackets (36) and (38). The first riser (26) and second riser (28) form a four-bar linkage assembly (40) with a first upper arm (42), a first lower arm (44), a second upper arm (46) and a second lower arm (48). The arms (42), (44), (46) and (48) are preferably constructed of hollow steel bars having a generally square cross section. The first upper arm (42) is pivotally secured within the channel (50) of the first riser (26) by a pin (52). Similarly, the first lower arm (44) is pivotally secured within the channel (50) of the first riser (26) by a pin (54). The second upper arm (46) is pivotally secured within a channel (56) of the second riser (28) by a pin (58) and the second lower arm (48) is secured within the channel (56) of the second riser (28) by a pin (60).

As shown in FIG. 2, the agricultural implement mount (10) is provided with a lift system (62). The lift system (62) has a first linear actuator (64), such as a hydraulic cylinder, pivotally secured within the channel (50) of the first riser (26) by a pin (66) and pivotally secured on the other end to arcuate steel plates (68) and (70). The arcuate steel plates (68) and (70) are welded to the first upper arm (42). Similarly, a second linear actuator (72) is secured within the channel (56) of the second riser (28) by a pin (74), and on the other end to a pair of arcuate plates (76) and (78) secured to and depending from the second upper arm (46).

Secured to the first upper arm (42) and second upper arm (46) is a lift bar assembly (80). The lift bar assembly (80) has a center steel bar (82) welded or otherwise secured to the first arm (42) and second upper arm (46). As shown in FIG. 2, a pair of steel corner brackets (88) and (90) are welded to the first upper arm (42) lift bar assembly (80) and second upper arm (46) to strengthen the connection therebetween. The lift bar assembly (80) also has a pair of securement cylinders (84) and (86) journaled to the ends of the steel bar (82).

Provided on the lift bar assembly (80) are a pair of keepers (92) and (94). The keeper (92) is a first plate (96) and a second plate (98) secured around the lift bar assembly (80) in a manner that allows the first plate (96) and second plate (98) to rotate in relationship thereto. As shown, the first plate (96) and second plate (98) are provided with a plurality of holes (100) and pins (102).

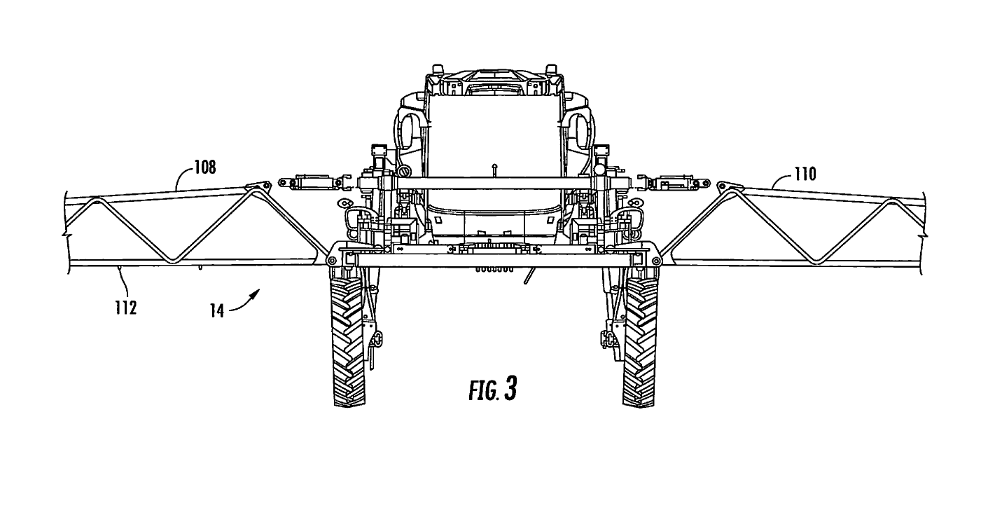

As shown in FIGS. 1 and 3, the agricultural implement (14) is provided with a first lateral boom (108) and a second lateral boom (110). While the booms (108) and (110) preferably are provided with spray nozzles (112) coupled to the fluid lines (20), the booms (108) and (110) may be provided with any desired elements.

As shown in FIG. 2, the agricultural implement (14) is provided with a support bar (114). Provided on the support bar (114) is a first post (116) and second post (118). Preferably, the posts (116) and (118) are constructed of solid steel welded to the support bar (114). Also secured to the support bar (114) is a first generally L-shaped support bracket (120) welded to the first post (116) and a second generally L-shaped support bracket (122) welded to the second post (118).

To attach the agricultural implement (14) to the mount (10), the plates (96) and (98) of the keeper (92) are provided on either side of the first post (116) and secured thereto by the pins (102) passing through the holes (100) in the plates (96) and (98) and holes (124) provided in the post (116). Similarly, plates (126) and (128) of the keeper (94) are provided on either side of the second post (118) and secured thereto by pins (130) passing through holes (132) in the plates (126) and (128) and holes (134) in the second post (118).

The free end (104) of the first lower arm (44) is positioned between the first post (116) and first bracket (120). The free end (104) is then secured by a pin (136) passing through a hole (138) in the bracket (120), a hole (140) in the free end (104) of the first lower arm (44) and a hole (142) in the first post (116). Preferably, a first wear-resistant sleeve (144) constructed of abrasion-resistant material is positioned over the pin (136) between the pin (130) and the first post (116) to reduce wear on the pin (136). A second wear-resistant sleeve (146) is positioned over the pin (136) between the pin (136) and the bracket (120). A third wear-resistant sleeve (148) is positioned over the pin (136), between the pin (136) and the free end (104) of the first lower arm (44).

In a similar manner, the free end (106) of the second lower arm (48) is provided between the bracket (122) and second post (118). A pin (150) is provided through a hole (152) in the bracket (122), a hole (154) in the free end (106) of the second lower arm (48) and a hole (156) in the second post (118). Three wear-resistant sleeves (158), (160) and (162) are provided around the pin (150) in a manner described above.

The lift system (62) may be used to present the agricultural implement (14) at the proper height for delivery of fluid from the tank (18) through the spray nozzles (112) on the booms (108), (110) and the support bar (114) to the crops (22) in the agricultural field (158). When it is desired to remove the agricultural implement (14) from the mount (10), a lift system (62) lowers the agricultural implement (14), the pins (102), (130), (136) and (150) are removed and the agricultural vehicle (12) may be reversed to pull the mount (10) away from the agricultural implement (14).

Although the invention has been described with respect to a preferred embodiment thereof, it is to be understood that it is not to be so limited since changes and modifications can be made therein which are within the full, intended scope of this invention as defined by the appended claims.

What is claimed is:

1. An agricultural implement mount system comprising:
(a) a crossbar;
(b) a first riser coupled to the crossbar;
(c) a second riser coupled to the crossbar;
(d) a first upper arm pivotably coupled to the first riser;
(e) a first lower arm:
(i) a first end pivotably coupled to the first riser; and
(ii) a second free end;
(f) a second upper arm pivotably coupled to the first riser;
(g) a second lower arm:
(i) a first end pivotably coupled to the first riser; and
(ii) a second free end;
(h) a lift bar coupled to the first upper arm and the second upper arm;
(i) an agricultural implement comprising:
(i) a support bar;
(ii) a first post coupled to the support bar; and
(iii) a second post coupled to the support bar;
(j) wherein the free end of the first lower arm is pivotably coupled to the first post;
(k) wherein the free end of the second lower arm is pivotably coupled to the second post; and
(l) wherein the first post is pivotably coupled to the lift bar; and
(m) wherein the second post is pivotably coupled to the lift bar.

2. The agricultural implement mount system of claim 1, wherein the first post is pivotably coupled to the lift bar by a keeper secured to the lift bar.

3. The agricultural implement mount system of claim 2, wherein the keeper is at least two plates provided on either side of the first post.

4. The agricultural implement mount system of claim 3, wherein at least two of the plates are secured to the post by a pin passing through at least two of the plates and the post.

5. The agricultural implement mount system of claim 3, wherein at least one plate is pivotably secured to either side of the lift bar.

6. The agricultural implement mount system of claim 1, further comprising a bracket secured to the support bar, wherein the free end of the first lower arm is provided between, and pivotably secured to, the first post and the bracket.

7. The agricultural implement mount system of claim 6, further comprising a pin passing through the first post, the free end of the first lower arm and the bracket.

8. The agricultural implement mount system of claim 6, wherein the bracket is secured to the first post.

9. The agricultural implement mount system of claim 8, further comprising a pin passing through the first post, the free end of the first lower arm and the bracket.

10. The agricultural implement mount system of claim 1, wherein the agricultural implement further comprises:
(a) a first lateral boom;
(b) a second lateral boom;
(c) wherein the first lateral boom and second lateral boom are coupled to the support bar;
(d) wherein the first lateral boom is not secured to the second lateral boom;
(e) wherein the first lateral boom is coupled to a first end of the lift bar; and
(f) wherein the second lateral boom is coupled to a second end of the lift bar.

11. The agricultural implement mount system of claim 10, further comprising a bracket secured to the support bar, wherein the free end of the first lower arm is provided between, and pivotably secured to, the first post and the bracket.

12. The agricultural implement mount system of claim 11, further comprising a pin passing through the first post, the free end of the first lower arm and the bracket.

13. The agricultural implement mount system of claim 10, wherein the bracket is secured to the first post.

14. The agricultural implement mount system of claim 1, wherein the lift bar comprises an interior bar and an abrasion resistant sleeve provided over the interior bar.

15. An agricultural implement mount system comprising:
(a) a four bar linkage assembly comprising:
(i) a first riser;
(ii) a first upper arm pivotably coupled to the first riser;
(iii) a first lower arm having a secured end pivotably coupled to the first riser and a free end;
(iv) a second riser;
(v) a second upper arm pivotably coupled to the second riser;
(vi) a second lower arm having a secured end pivotably coupled to the second riser and a free end;
(b) a lift arm secured to the first upper arm and the second upper arm;
(c) an agricultural implement comprising:
(i) a support bar;
(ii) a first lateral boom coupled to the support bar;
(iii) a second lateral boom coupled to the support bar;
(iv) a post pivotably secured to the support bar between the first lateral boom and the second lateral boom;
(d) wherein the post is pivotably secured to the free end of the first lower arm and to the lift arm.

16. The agricultural implement mount system of claim 15, further comprising a bracket secured to the support bar, wherein the free end of the first lower arm is provided between, and pivotably secured to, the post and the bracket.

17. The agricultural implement mount system of claim 16, further comprising a pin passing through the post, the free end of the first lower arm and the bracket.

18. An agricultural implement mount system comprising:
(a) a generally U-shaped frame;
(b) a four bar linkage pivotably coupled to the frame, wherein the linkage has at least two free ends;
(c) a lift bar secured to the linkage at at-least two points where the two points are greater than one meter apart;
(d) an agricultural implement comprising:
(i) a support bar;
(ii) a first lateral boom coupled to the support bar;
(iii) a second lateral boom coupled to the support bar;
(iv) a first post pivotably secured to the support bar between the first lateral boom and the second lateral boom; and
(v) a second post pivotably secured to the support bar between the first lateral boom and the second lateral boom;
(e) wherein at least one free end of the linkage is pivotably coupled to the first post;
(f) wherein at least one free end of the linkage is pivotably coupled to the second post;
(g) wherein the lift bar is pivotably secured to the first post; and
(h) wherein the lift bar is pivotably secured to the second post.

19. The agricultural implement mount system of claim 18, further comprising a bracket secured to the support bar, wherein the free end of the first lower arm is provided between, and pivotably secured to, the post and the bracket.

20. The agricultural implement mount system of claim 19, wherein the lift bar comprises an interior bar and an abrasion resistant sleeve provided over the interior bar.
